(19) United States
(12) Patent Application Publication
(10) Pub. No.: US 2002/0077722 A1
(43) Pub. Date: Jun. 20, 2002

(54) Method and system for electronic tracking of packaging

(76) Inventors: Scott S. Haraburda, Clinton, IN (US); Rex E. Masterson, Evansville, IN (US); Angelika H. Clark, Mt. Vernon, IN (US); Michael S. Davis, Mt. Vernon, IN (US); Clarence S. Clowers, Mt. Vernon, IN (US); Dale W. Dorris, Evansville, IN (US); Ronald D. Craddock, McLeansboro, IL (US)

Correspondence Address: CANTOR COLBURN, LLP, 55 GRIFFIN ROAD SOUTH, BLOOMFIELD, CT, 06002

(21) Appl. No.: 09/742,159

(22) Filed: Dec. 20, 2000

(51) Int. Cl. G06F 7/00

(52) U.S. Cl. 700/223

(57) ABSTRACT

An exemplary embodiment is a method and system for electronic tracking of packaging corresponding to a product in a package on a production line. The system includes a processor integrated with the production line for identifying the product in the package, determining whether the product in the package has production history data, determining a first disposition of the product in the package based on the production history data, determining whether the product in the package is discrepant based on the first disposition, assigning a destination for the product in the package if the product in the package is not discrepant and generating tracking data based on the destination and assigning a second disposition for the product in the package if the product in the package is discrepant and generating tracking data based on the second disposition. A network is connected to the processor, and a user system is coupled to the network. A database is coupled to the processor for storing data relating to the product in the package.

### BACKGROUND

The invention relates generally to production line management, and more specifically, to a method and system for electronic tracking of packaging.

Many production lines, such as in the plastics industries, involve numerous processes to create an end product. In production lines where intricate or otherwise information-sensitive manufacturing is performed, correctly transferring critical production information is essential. Any number of factors may be significant to the proper running of the production line at any given time, but without the efficient, fast and accurate transfer of this information, numerous errors may occur.

For example, in the finishing of plastic pellets (which have been produced previously in a resin process), the finishing process encompasses adding various materials to the pellets. The added materials may be flame-retardants, pigment, glass, etc., depending on the final use thereof. After the addition, or what is typically called the compounding process, the pellets are extruded into an end product.

Upon completion of production, the end product is typically packaged and/or stored and shipped to the customer. Due to the nature of certain end products, such as plastic pellets, correctly packaging, identifying and tracking the products is valuable. For example, end products having different properties and characteristics, but not distinguishable from each other by the naked eye, have a potential for being incorrectly packaged and labeled. Plus, discrepant end products or end products intended for recycling may be inadvertently packaged and delivered to a customer. Depending upon the application, such errors can be harmful. Therefore, accurately tracking the packaging of the end product is important.

Typically, tracking the packaging of the end product is logistically complex and difficult to manage. Routinely, tracking of packaging is performed with very little knowledge about the end product and its manufacturing history. Due potential human error with manual tracking of packaging methods, discrepant, questionable, flawed or incorrect end products may be packaged and ultimately delivered to a customer. Further, critical and valuable information about an end product and its manufacturing history, is seldom traced due to the exhaustive manual labor effort required. However, such information may be useful in optimizing the tracking of end product packaging, and preventing errors. For example, to determine the root cause of a problem associated with an end product, the manufacturing and storage history of the product may be important. However, if such information is lost during the packaging process, root cause analysis may be difficult, if not impossible. Also, end product mishandling is not usually discovered because it is not routinely documented or traceable. Therefore, a lack of accountability may also exist.

The historical information associated with an end product (such as production equipment settings, raw material identification and quality assurance (QA) data (such as physical properties and visual inspection results) is typically manually entered onto a production “run sheet.” Manual entry to the run sheet is required every time a new product, or production lot, is run on each production line (approximately once every eight hours for each production line). The task is manually intensive, requiring the operator to: 1) search for an appropriate unique control plan; 2) enter each setting on the equipment; and 3) write each setting on the run sheet. Therefore, valuable operator time is used, and manual entry often results in clerical data entry errors that may affect the quality and consistency of the products being produced. Moreover, the operator is often required to search for the handwritten data, which may be located in several different locations throughout the production site. In other words, the current practices are ripe for error.

Routinely, production is performed with very little information or knowledge about the inputs to the manufacturing process, namely the raw material and its physical properties. Again, this lack of information may make it difficult for manufacturing engineers and quality specialists to improve the quality of products, especially when trying to determine the root cause of a problem that surfaces after the end product has been packaged and/or delivered to the customer. As previously discussed, methods for tracking of end product packaging are typically manually intensive, rudimentary and ripe for error.

Thus, there is a need for a more efficient, fast and accurate method and system for production line management.

### SUMMARY

An exemplary embodiment is a method and system for electronic tracking of packaging corresponding to a product in a package on a production line. The system includes a processor integrated with the production line for identifying the product in the package, determining whether the product in the package has production history data, determining a first disposition of the product in the package based on the production history data, determining whether the product in the package is discrepant based on the first disposition, assigning a destination for the product in the package if the product in the package is not discrepant and generating tracking data based on the destination and assigning a second disposition for the product in the package if the product in the package is discrepant and generating tracking data based on the second disposition. A network is connected to the processor, and a user system is coupled to the network. A database is coupled to the processor for storing data relating to the product in the package.

### BRIEF DESCRIPTION OF THE DRAWINGS

Referring now to the drawings wherein like elements are numbered alike in several FIGURES:

FIG. 1 depicts an exemplary electronic production run sheet in an embodiment of the invention.

FIG. 2 is a block diagram of a computer system in an embodiment of the invention.

FIGS. 3A-3B illustrate an exemplary method for electronic tracking of packaging in an embodiment of the invention.

### DETAILED DESCRIPTION

This application relates generally to commonly owned and invented U.S. application Ser. No. 09/498,035, filed Feb. 4, 2000, entitled “Method and System for Electronically Capturing, Storing, Searching and Retrieving Production Data,” the teachings of which are incorporated by reference herein.

As previously discussed, the historical information associated with a product is typically manually entered to the run sheet every time a new product or production lot is run on each production line. In contrast, the invention does not require such manual entry, and therefore, the errors and problems associated with manual entry of production line data are eliminated. Therefore, historical analysis of the product is quicker and more accurate. The information contained in the electronic production run sheet 80 helps to improve the analysis of the product (such as providing useful information for determining the root cause of a problem) and optimize the production process through improved tracking of the identity, location, quantity and physical properties of the raw materials used in the product.

Furthermore, cumbersome manual logistical tracking of packaging techniques are eliminated by the use of a method and system that electronically tracks the packaging of the product. Thus, the product may be accurately and efficiently packaged and tracked from production through customer delivery without the errors and problems associated with manual techniques. Also, discrepant products (such as those designated for recycling or scrapping) may be prevented from being packaged and scheduled for client delivery. Note that the term “package” may include a large bulk package, such as a rail car and tractor trailer, as well as a smaller package, such as a box, bag and the like.

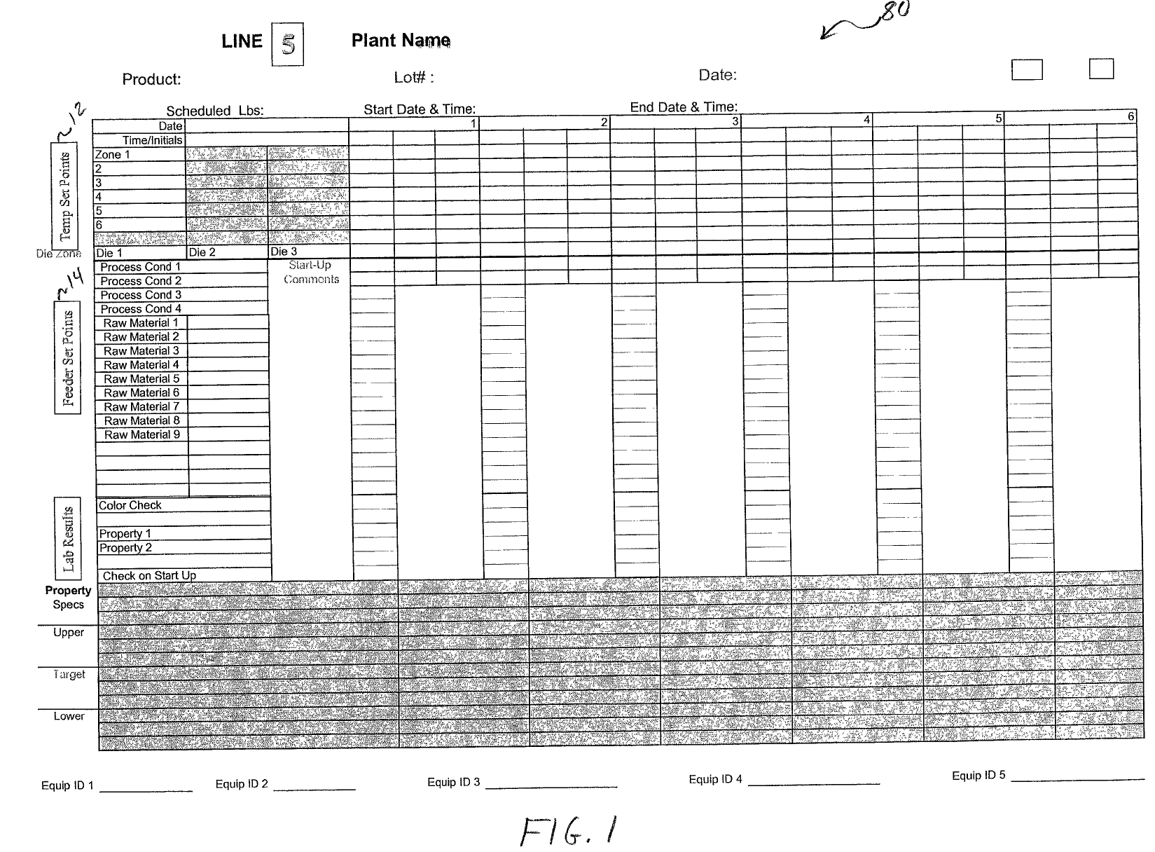

In general, an embodiment includes an electronic production run sheet 80, FIG. 1, containing production readings and quality data for a particular production line product. The manual version of a run sheet is usually in a tabular form with various columns in which the operator must record the production information by hand. After recording the product and lot number, date and time, the operator must hand write the temperature set points at 12 for the various zones of the extruder. The operator must also record various feeder set points 14.

Although the system of an embodiment is described with relation to plastics finishing, it should be appreciated that the system and method described herein can be applied to various other manufacturing and data retrieval and storage environments.

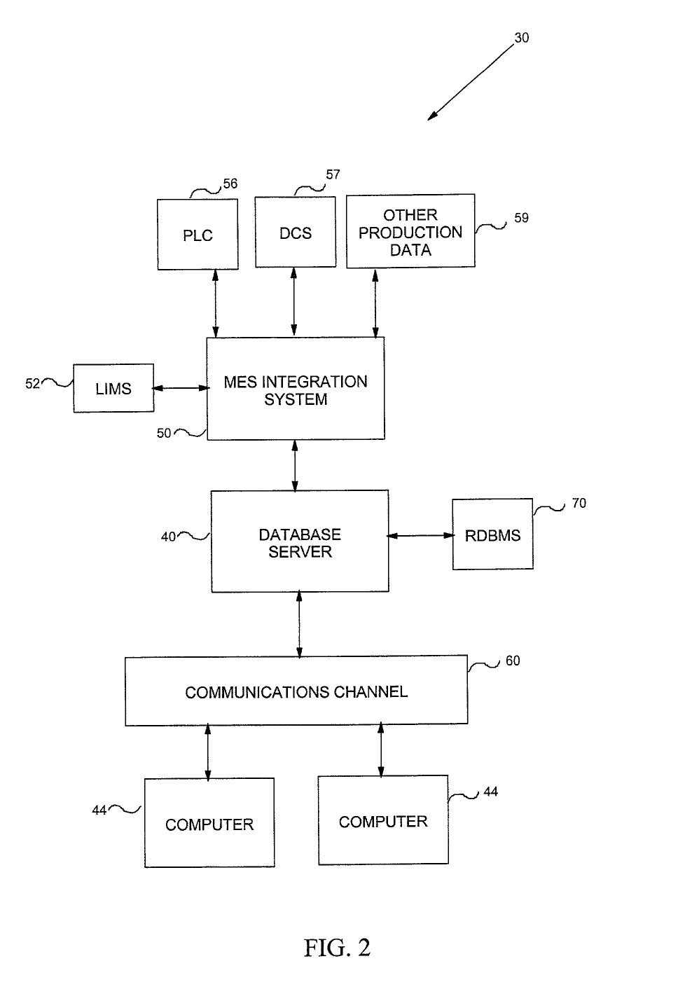

An embodiment utilizes a manufacturing execution system (MES) computer system 30. Referring to FIG. 2, the computer architecture of the MES computer system 30 will be described. The MES computer system 30 includes a database server 40 and computers 44. Although only two computers 44 are shown for simplicity it should be appreciated that a plurality of computers can be located at different locations in the production site for use by a plurality of operators. Moreover the database server 40 can be identical to computer 44 and is distinguishable as an embodiment only in that server 40 is the primary data storage source with which data stored in computers 44 can be synchronized therewith.

Computer(s) 44 are coupled to the database server 40 by communications channel 60. Communications channel 60 can be a network, such as a wide area network (WAN), local area network (LAN), Ethernet, intranet, a direct cable connection, a connection via phone lines and modems, or the like. Further, communications channel 60 can be continuous or intermittent and can be any mechanism for providing the communications described below. For example, communications channel 60 can include removable media, such as a diskette. Data can be sent over communications channel 60 in any appropriate format, such as e-mail in simple mail transfer protocol (SMTP), as attachments to email, as ASCII or binary files using file transfer protocol (FTP), or the like.

Even further, communications channel 60 can be the Internet. In such an embodiment, computer(s) 44 execute a user application (e.g., web browser) for interacting with the database server 40. Communication with computer(s) 44 can be achieved in any manner consistent with Internet information transfer, including but not limited to, HTTP and FTP, or a client/server connection.

Likewise, system components may be located remotely from each other and coupled via communications channel 60. For example, the database server 40 may be located off-site of the production line and communicates with corresponding components via communications channel 60 as a network, such as the Internet, WAN, LAN, Ethernet, intranet, a direct cable connection, a connection via phone lines and modems, or the like. Such remote locating is useful if, for example, the production facility environment is too extreme for the components.

The database server 40 is managed by a relational database management system (RDBMS) 70, such as the ORACLE RELATIONAL DATABASE MANAGEMENT SYSTEM by Oracle Corporation of Redwood Shores, Calif. RDBMS 70 manages a relational database to store the data. The data records, data tables, and data relationships contained in the database managed by RDBMS 70 enable the MES computer system 30 to provide increased reliability in searching and analyzing quality assurance (QA) lab testing data.

In the MES computer system 30, the database server 40 is a computer having sufficient resources to support RDBMS 70. Moreover, the database server 40 supports multi-operator access to RDBMS 70 over a computer network. Each operator computer terminal 44 should be sufficient to support an operating system such as WINDOWS 98, UNIX or other similar operating systems. These systems are used for communication with the Laboratory Information Management System (LIMS) 52, which executes on computers 44, as well.

As discussed, computers 44 execute application programs, which communicate with RDBMS 70 to query the databases managed by RDBMS 70 and to provide data for that database. The LIMS database 52 in this process involves the display and storage of the lab tests, along with the required specifications, and is another source of production data, such as the test results of the product properties. The data captured by the LIMS is displayed using SQC graphs to indicate quality of the product and/or process. The data can be captured each time a QA lab test occurs (or at other convenient times), also known as a production line check.

The MES computer system 30 includes a variety of features. Data exchange between the database server 40 and the different databases, such as LIMS 52, can occur due to the use of the MES integration system 50. This acts as an interface between the database server 40 and LIMS 52, programmable logic controller (PLC) interface 56 with production real-time data and other data, such as product location and tracking (before and after packaging) via another production data database 59. Data exchange also occurs due to the use of a compliant language such as VISUAL BASIC (VB) from Microsoft Corporation of Redmond, Washington. If necessary, functionality modules can be used to group the production data by batches or lots.

A PLC interface 56, for example GE 90-70, allows for the snap shot of the process to be retrieved at a particular sample time. The PLC interface 56 allows production parameters to be set and controlled. As such, this system has the electronic capability to capture the production parameters and send them to a database system with the appropriate date/time stamps.

The VB application programming interface (API) program also allows the operator to retrieve the production run data in the snap shot format by entering the line number, product number or date in the appropriate windows of the electronic production run sheet 80 screen. The line number and product number are pull-down menus that the operators can select. The date is a manual entry block. Each of these allows the operator to search the database system for historical batches (or lots). Because there are several thousand lots made each year, this makes it easier for data retrieval.

The data from a particular line check can be maintained for at least three years due to VB API access and a 40-gigabyte RAID -5-disk array. The particular storage amount is dependent upon the storage capacity, whereas the required length of storage is dependent upon policy dictating document retention.

The VB API program also allows the operator to print a hard copy of the electronic production run sheet 80 and to print a pre-configured report for the production run. This will retrieve the appropriate batch (or lot) production and QA lab test data for printout on the pre-configured report format, similar to the one displayed in FIG. 1.

As discussed above, a statistical quality control (SQC) graph can chart the melt flow index, melt viscosity or any other property of interest due to RDBMS 70, and other databases. The data for the SQC charts would come from the various databases, depending upon which property was chosen for graphing. The actual charting of the SQC graph will either be done using existing statistical graphing packages or through programming using generic (well-known) equations.

The database server 40 acts as a universal user interface due to RDMS 70, GE 90-70 PLC interface 56, EDCP RDBMS, VB API access. Furthermore, utilizing standard technology and tool sets such as VB, structured query languages (SQL), object linking and embedding (OLE) for process control, open database connectors (ODBC) and ActiveX controls also allow for universal user interface.

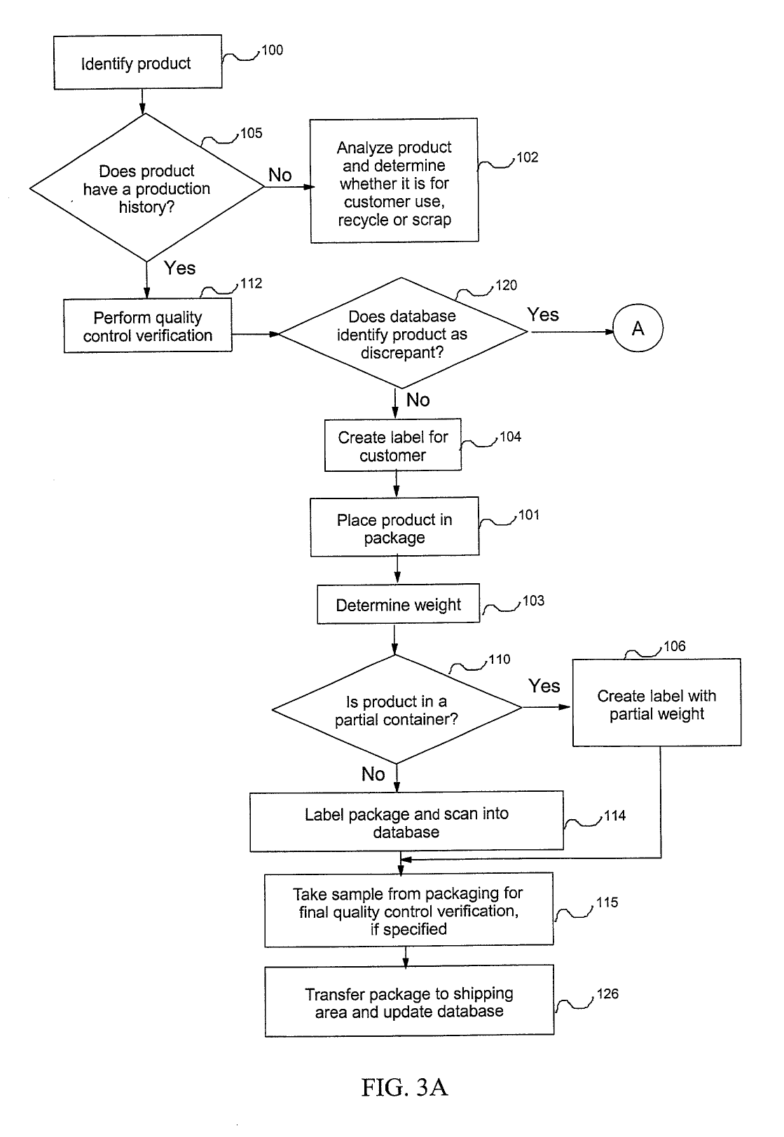

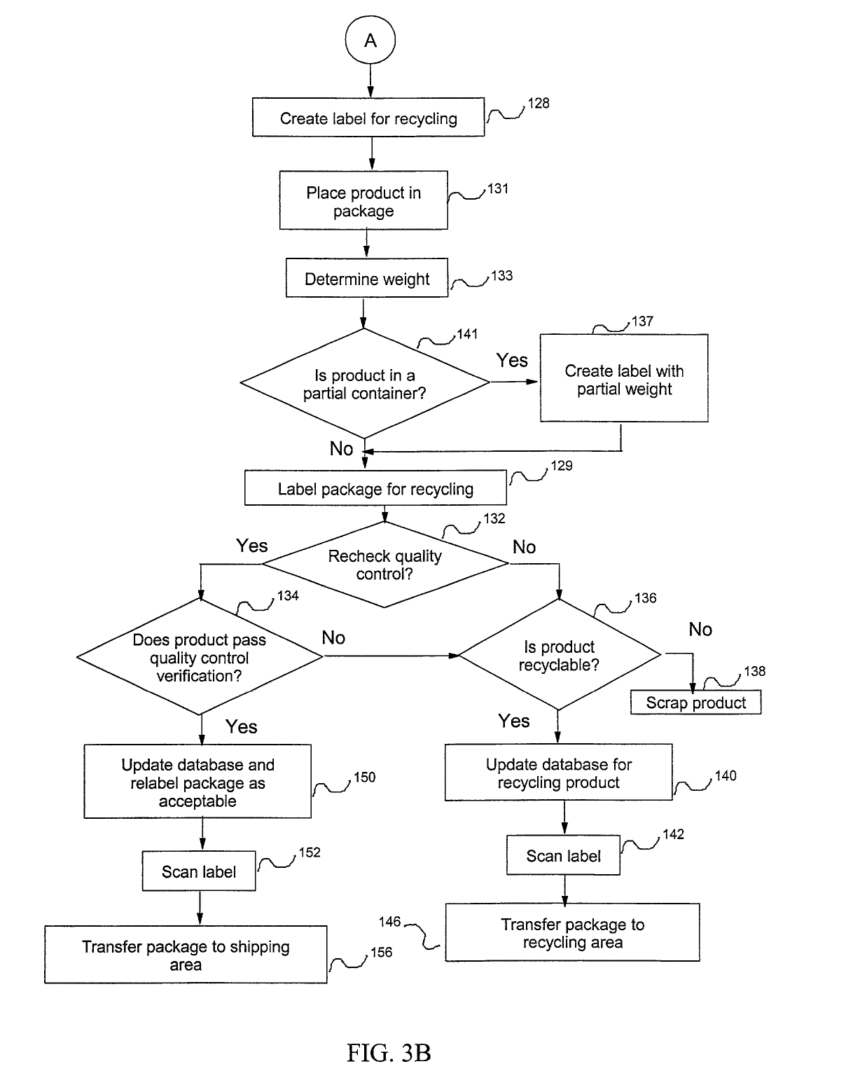

FIGS. 3A-3B illustrate an exemplary method for electronic tracking of packaging. The method of FIGS. 3A-3B may be implemented by an operator using one of the computer(s) 44 or even automatically based on production schedule information previously entered to the MES computer system 30. As discussed, production information for a product is collected via the electronic production run sheet 80. This information is archived and used to improve accuracy and efficiency with tracking of packaging.

First, in step 100, the product is identified. Step 105 determines whether the product has a production history. As previously discussed, the production history may be maintained in a database. Note that although an embodiment utilizing the production run sheet 80 for collecting data has been described, further embodiments may utilize other methods for collecting the data and archiving to a database. If the product has no production history, in step 102, the product is analyzed and determined to be for customer use, recycle or scrap. However, if step 105 determines that the product has a production history, then in step 112, a quality control verification is performed. Of course, quality control verification is a function of the product and its end use. Numerous techniques may be utilized to determine whether a product meets a manufacturer's quality requirements. Next, step 120 determines whether the product is identified as a discrepant product. If the product is not identified as a discrepant product, then, in step 104, a label is created to identify the product for customer use. Next, in step 101, the product is placed in a package and its weight is determined in step 103. Note that a scale electronically controls the “fill” to a target weight within a given tolerance. Step 110 determines whether the product is in a partial container. If so, then in step 106, a label with the partial weight is created and scanned. If the product is not in a partial container, in step 114, the package is labeled and scanned. Next, both steps 106 and 114 flow to step 115, where a product sample is taken from the packaging for a final quality control verification, if specified. Then, in step 126, the package is transferred to the shipping area and the database is updated.

If, in step 120, the database identifies the product as discrepant, a label designating the product for recycling is created in step 128. Next, in step 131, the product is placed in a package and its weight is determined in step 133. Step 141 determines whether the product is in a partial container. If so, then in step 137, a label with the partial weight is created and scanned. If the product is not in a partial container, in step 129, the package is labeled for recycling. In step 132, quality control is verified again (rechecked). Step 134 determines whether the product passes the quality control verification. If not, step 136 determines whether the product is recyclable. If not, the product is scrapped in step 138. If the product is recyclable, in step 140, the database is updated. In step 142, the label is scanned, and in step 146, the package is transferred to a recycling area. If, in step 134, the product passes quality control verification, then in step 150, the database is updated and the package is relabeled as acceptable. In step 152, the label is scanned. In step 156, the package is transferred to the shipping area.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Note that another embodiment may determine whether an operator is involved in scanning the labels. If so, the operator's identity is obtained and downloaded to the database. The operator's identity may be useful when determining accountability for errors. The operator's identity may be obtained several ways, such as via keyed entry, voice input, bar-code type scanning of the operator's identification badge, and the identity may even be automatically entered based on production information previously entered to the MES computer system 30.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for electronic tracking of packaging corresponding to a product in a package on a production line, the system comprising:
a processor integrated with said production line for identifying said product in said package, determining whether said product in said package has production history data, determining a first disposition of said product in said package based on said production history data, performing a first quality control verification of said product in said package, determining whether said product in said package is discrepant based on said quality control verification, assigning a destination for said product in said package if said product in said package is not discrepant, and generating tracking data based on said destination, and assigning a second disposition for said product in said package if said product in said package is discrepant, and generating tracking data based on said second disposition;
a network coupled to said processor;
a user system coupled to said network; and
a database coupled to said processor for storing data relating to said product in said package.

2. The system of claim 1, further including said processor generating an electronic production run sheet including said production history data.

3. The system of claim 1, wherein said determining said first disposition includes:
determining whether said product in said package is to be scrapped.

4. The system of claim 1, wherein said assigning said destination includes labeling said package for customer use.

5. The system of claim 1, further including said processor determining the weight of said product in said package and labeling said package with said weight.

6. The system of claim 1, further including said processor performing a final quality control verification from a sample of said product in said package.

7. The system of claim 1, wherein said assigning said second disposition includes labeling said package for recycling.

8. The system of claim 7, further including said processor determining the weight of said product in said package and labeling said package with said weight.

9. The system of claim 7, further including said processor:
performing a second quality control verification;
determining a result of said second quality control verification; and
coding a destination for said product in said package based on said result.

10. The system of claim 9, wherein said coding includes:
labeling said package with a bar-coded destination label; and
scanning said bar-coded destination label into a database.

11. A method for electronic tracking of packaging corresponding to a product in a package on a production line, the method comprising:
identifying said product in said package;
determining whether said product in said package has production history data;
determining a first disposition of said product in said package based on said production history data;
performing a first quality control verification of said product in said package;
determining whether said product in said package is discrepant based on said quality control verification;
assigning a destination for said product in said package if said product in said package is not discrepant, and generating tracking data based on said destination; and
assigning a second disposition for said product in said package if said product in said package is discrepant, and generating tracking data based on said second disposition.

12. The method of claim 11, further including generating an electronic production run sheet including said production history data.

13. The method of claim 11, wherein said determining said first disposition includes:
determining whether said product in said package is to be scrapped.

14. The method of claim 11, wherein said assigning said destination includes labeling said package for customer use.

15. The method of claim 11, further including determining the weight of said product in said package and labeling said package with said weight.

16. The method of claim 11, further including performing a final quality control verification from a sample of said product in said package.

17. The method of claim 11, wherein said assigning said second disposition includes labeling said package for recycling.

18. The method of claim 17, further including determining the weight of said product in said package and labeling said package with said weight.

19. The method of claim 17, further including:
performing a second quality control verification;
determining a result of said second quality control verification; and
coding a destination for said product in said package based on said result.

20. The method of claim 19, wherein said coding includes:
labeling said package with a bar-coded destination label; and
scanning said bar-coded destination label into a database.

21. A storage medium encoded with machine-readable computer program code for electronic tracking of packaging corresponding to a product in a package on a production line, said storage medium including instructions for causing a processor to implement a method comprising:
identifying said product in said package;
determining whether said product in said package has production history data;
determining a first disposition of said product in said package based on said production history data;
performing a first quality control verification of said product in said package;
determining whether said product in said package is discrepant based on said quality control verification;
assigning a destination for said product in said package if said product in said package is not discrepant, and generating tracking data based on said destination; and
assigning a second disposition for said product in said package if said product in said package is discrepant, and generating tracking data based on said second disposition.

22. The storage medium of claim 21, further including instructions for causing said processor to implement generating an electronic production run sheet including said production history data.

23. The storage medium of claim 21, wherein said determining said first disposition includes:
determining whether said product in said package is to be scrapped.

24. The storage medium of claim 21, wherein said assigning said destination includes labeling said package for customer use.

25. The storage medium of claim 21, further including instructions for causing said processor to implement determining the weight of said product in said package and labeling said package with said weight.

26. The storage medium of claim 21, further including instructions for causing said processor to implement performing a final quality control verification from a sample of said product in said package.

27. The storage medium of claim 21, wherein said assigning said second disposition includes labeling said package for recycling.

28. The storage medium of claim 27, further including instructions for causing said processor to implement determining the weight of said product in said package and labeling said package with said weight.

29. The storage medium of claim 27, further including instructions for causing said processor to implement:
performing a second quality control verification;
determining a result of said second quality control verification; and
coding a destination for said product in said package based on said result.

30. The storage medium of claim 29, wherein said coding includes:
labeling said package with a bar-coded destination label; and
scanning said bar-coded destination label into a database.

31. A computer data signal for electronic tracking of packaging corresponding to a product in a package on a production line, said computer data signal comprising code configured to cause a processor to implement a method comprising:
identifying said product in said package;
determining whether said product in said package has production history data;
determining a first disposition of said product in said package based on said production history data;
performing a first quality control verification of said product in said package;
determining whether said product in said package is discrepant based on said quality control verification;
assigning a destination for said product in said package if said product in said package is not discrepant, and generating tracking data based on said destination; and
assigning a second disposition for said product in said package if said product in said package is discrepant, and generating tracking data based on said second disposition.

32. The computer data signal of claim 31, further including code configured to cause said processor to implement generating an electronic production run sheet including said production history data.

33. The computer data signal of claim 31, wherein said determining said first disposition includes:
determining whether said product in said package is to be scrapped.

34. The computer data signal of claim 31, wherein said assigning said destination includes labeling said package for customer use.

35. The computer data signal of claim 31, further including code configured to cause said processor to implement determining the weight of said product in said package and labeling said package with said weight.

36. The computer data signal of claim 31, further including code configured to cause said processor to implement performing a final quality control verification from a sample of said product in said package.

37. The computer data signal of claim 31, wherein said assigning said second disposition includes labeling said package for recycling.

38. The computer data signal of claim 37, further including code configured to cause said processor to implement determining the weight of said product in said package and labeling said package with said weight.

39. The computer data signal of claim 37, further including code configured to cause said processor to implement:
performing a second quality control verification;
determining a result of said second quality control verification; and
coding a destination for said product in said package based on said result.

40. The computer data signal of claim 39, wherein said coding includes:
labeling said package with a bar-coded destination label; and
scanning said bar-coded destination label into a database.
